(19) United States
(12) Patent Application Publication
(10) Pub. No.: US 2016/0147437 A1
(43) Pub. Date: May 26, 2016

(54) ELECTRONIC DEVICE AND METHOD FOR HANDWRITING

(71) Applicant: Kabushiki Kaisha Toshiba, Tokyo (JP)

(72) Inventor: Hideki Tsutsui, Kawasaki Kanagawa (JP)

(21) Appl. No.: 15/009,622

(22) Filed: Jan. 28, 2016

Related U.S. Application Data
(63) Continuation of application No. PCT/JP2014/050961, filed on Jan. 20, 2014.

(51) Int. Cl. G06F 3/0488

(52) U.S. Cl. CPC G06F 3/04883

(57) ABSTRACT

According to one embodiment, an electronic device receives at least one first stroke made on a document displayed on a screen, displays the at least one first stroke on the screen, determines a first handwriting candidate including a second stroke and a third stroke subsequent to the second stroke in response to an input of the at least one first stroke, and displays the first handwriting candidate on the screen. The electronic device receives a fourth stroke overlapping with an display area of the third stroke made on the screen, and enters not the third stroke but both the second stroke and the fourth stroke into the document in response to an input of the fourth stroke.

### CROSS REFERENCE TO RELATED APPLICATIONS

This application is a Continuation application of PCT Application No. PCT/JP2014/050961, filed Jan. 20, 2014, the entire contents of which are incorporated herein by reference.

### FIELD

Embodiments described herein relate generally to technology for handwriting.

### BACKGROUND

In recent years, various electronic devices such as tablet computers, PDAs, and smartphones have been developed. Most of the electronic devices of these types comprise a touchscreen display to facilitate a user input operation.

In addition, electronic devices capable of handling handwritten character strings have also been recently developed.

However, conventional handwriting processing does not support a technique for smoothly inputting a number of strokes by handwriting.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic device according to an embodiment.

FIG. 2 is an exemplary illustration showing cooperation between the electronic device shown in FIG. 1 and an external device.

FIG. 3 is an illustration showing an example of a handwritten document to be handwritten on a touchscreen display of the electronic device shown in FIG. 1.

FIG. 4 is an exemplary illustration for explanation of time-series information corresponding to the handwriting document shown in FIG. 3.

FIG. 5 is an exemplary block diagram showing a system configuration of the electronic device shown in FIG. 1.

FIG. 6 is an exemplary block diagram showing a functional configuration of a handwritten notebook application program executed by the electronic device shown in FIG. 1.

FIG. 7 is an exemplary flowchart for explanation of steps of handwriting suggestion processing executed by the electronic device shown in FIG. 1.

FIG. 8 is an illustration showing an example of a handwritten stroke displayed on a screen of the electronic device shown in FIG. 1.

FIG. 9 is an illustration showing an example of a suggested stroke string (handwriting candidate) displayed by the electronic device shown in FIG. 1.

FIG. 10 is an exemplary illustration showing a state in which the suggested stroke string shown in FIG. 9 is displayed at a position corresponding to the handwriting stroke shown in FIG. 8.

FIG. 11 is an exemplary illustration showing a state in which the handwritten stroke is overwritten on an area corresponding to a part of the displayed suggested stroke string.

FIG. 12 is an exemplary illustration showing an operation of partially adopting the suggested stroke string as an input in response to the overwriting of the handwritten stroke.

FIG. 13 is an exemplary view showing a state in which the handwriting input operation is continued while ignoring the displayed suggested stroke string.

FIG. 14 is an exemplary illustration showing an operation of making the overall suggested stroke string unaccepted by continuation of the handwriting input operation.

FIG. 15 is an illustration showing an example of a handwritten stroke displayed on the screen of the electronic device shown in FIG. 1.

FIG. 16 is an illustration showing an example of the suggested stroke string displayed by the electronic device shown in FIG. 1.

FIG. 17 is an exemplary illustration showing a state in which the suggested stroke string shown in FIG. 16 is displayed at a position corresponding to the handwritten stroke shown in FIG. 15.

FIG. 18 is an exemplary illustration showing a state in which the handwritten stroke has been overwritten on an area corresponding to a part of the displayed suggested stroke string.

FIG. 19 is an exemplary illustration showing an operation of partially adopting the suggested stroke string in response to the overwriting of the handwritten stroke.

FIG. 20 is an illustration showing an example of a handwritten stroke displayed on the screen of the electronic device shown in FIG. 1.

FIG. 21 is an illustration showing an example of the suggested stroke string displayed by the electronic device shown in FIG. 1.

FIG. 22 is an exemplary illustration showing a state in which the suggested stroke string shown in FIG. 21 is displayed at a position corresponding to the handwritten stroke shown in FIG. 20.

FIG. 23 is an exemplary illustration showing a state in which the handwritten stroke has been overwritten in an area corresponding to a part of the displayed suggested stroke string.

FIG. 24 is an exemplary illustration showing an operation of partially adopting the suggested stroke string as an input in response to the overwriting of the handwritten stroke.

FIG. 25 is an illustration showing an example of a handwritten stroke displayed on the screen of the electronic device shown in FIG. 1.

FIG. 26 is an illustration showing an example of the suggested stroke string displayed by the electronic device shown in FIG. 1.

FIG. 27 is an exemplary illustration showing a state in which the suggested stroke string shown in FIG. 26 is displayed at a position corresponding to the handwritten stroke shown in FIG. 25.

FIG. 28 is an exemplary illustration showing a state in which the handwritten stroke in a predetermined shape has been overwritten in an area corresponding to a part of the displayed suggested stroke string.

FIG. 29 is an exemplary illustration showing an operation of making a part or an entire body of the suggested stroke string unadopted in response to the overwriting of the handwritten stroke in a predetermined shape.

FIG. 30 is an illustration showing an example of a handwriting candidates displayed on the screen of the electronic device shown in FIG. 1.

FIG. 31 is an illustration showing an example of a handwritten stroke displayed on the screen of the electronic device shown in FIG. 1.

FIG. 32 is an illustration showing an example of the suggested stroke string displayed by the electronic device shown in FIG. 1.

FIG. 33 is an exemplary illustration showing a state in which the suggested stroke string shown in FIG. 32 is displayed at a position corresponding to the handwritten stroke shown in FIG. 31.

FIG. 34 is an exemplary illustration showing a state in which the handwritten stroke has been overwritten on an area corresponding to a part of the displayed suggested stroke string.

FIG. 35 is an exemplary illustration showing an operation of partially adopting the suggested stroke string as an input in response to the overwriting of the handwritten stroke.

FIG. 36 is an illustration showing an example of the handwritten stroke displayed on the screen of the electronic device shown in FIG. 1.

FIG. 37 is an illustration showing an example of the suggested stroke string displayed by the electronic device shown in FIG. 1.

FIG. 38 is an exemplary illustration showing a state in which the suggested stroke string shown in FIG. 37 is displayed at a position corresponding to the handwritten stroke shown in FIG. 36.

FIG. 39 is an exemplary illustration showing a state in which the handwritten stroke has been overwritten on an area corresponding to a part of the displayed suggested stroke string.

FIG. 40 is an exemplary illustration showing an operation of partially adopting the suggested stroke string as an input in response to the overwriting of the handwritten stroke.

FIG. 41 is an exemplary illustration showing a state in which the suggested stroke string corresponding to the input stroke is displayed.

FIG. 42 is an exemplary illustration showing a state in which the stroke in a predetermined shape has been input in an area corresponding to a part of the suggested stroke string shown in FIG. 41.

FIG. 43 is an exemplary illustration showing an operation of adopting a part or an entire body of the suggested stroke string in response to input of the stroke in a predetermined shape shown in FIG. 42.

FIG. 44 is an exemplary illustration showing a state in which the stroke in a predetermined shape has been input in an area corresponding to a part of a candidate list.

FIG. 45 is an exemplary illustration showing an operation of adopting a part or an entire body of the suggested stroke string in response to input of the stroke in a predetermined shape shown in FIG. 44.

### DETAILED DESCRIPTION

Various embodiments will be described hereinafter with reference to the accompanying drawings.

In general, according to one embodiment, an electronic device comprises a display, a memory and a hardware processor. The display is configured to detect a stroke made on a screen of the display and display the stroke on the screen. The memory is configured to store a document. The hardware processor displays the document on the screen, receives at least one first stroke made on the document displayed on the screen, displays the at least one first stroke on the screen, determines a first handwriting candidate comprising a second stroke and a third stroke subsequent to the second stroke in response to an input of the at least one first stroke, and displays the first handwriting candidate on the screen. The hardware processor receives a fourth stroke overlapping with an display area of the third stroke made on the screen, and enters not the third stroke but both the second stroke and the fourth stroke into the document in response to an input of the fourth stroke.

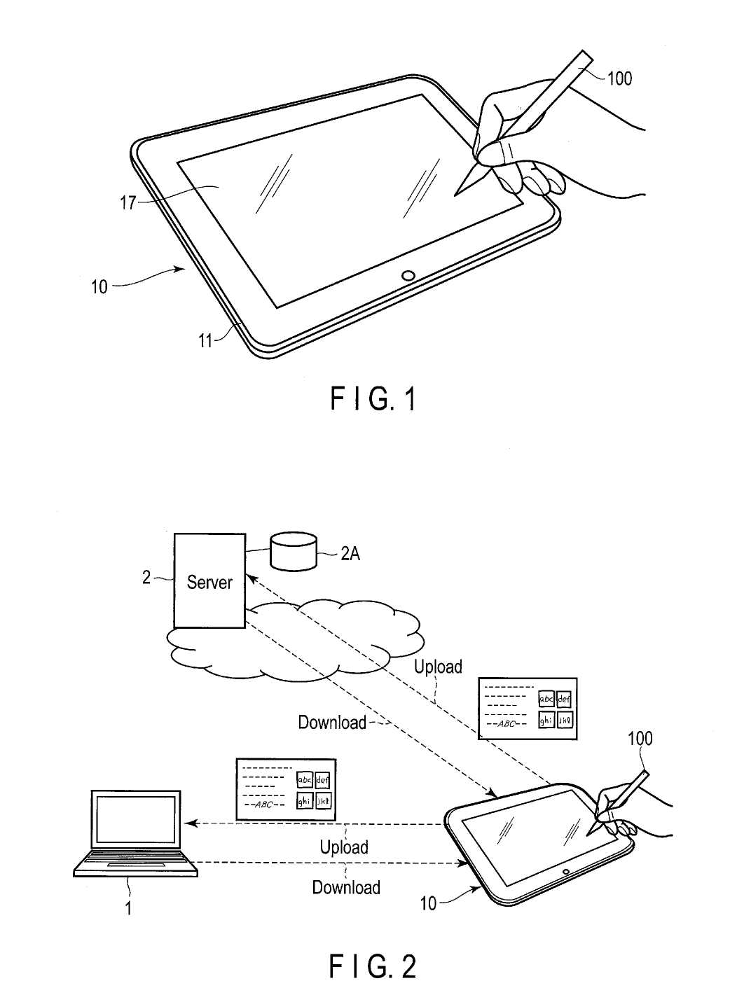

FIG. 1 is a perspective view showing an appearance of an electronic device according to one of the embodiments. The electronic device is, for example, a pen-based portable electronic device which enables handwriting input using a pen (stylus) or a finger. The electronic device can be realized as a tablet computer, a notebook-type personal computer, a smartphone, a PDA or the like. It is hereinafter assumed that the electronic device is realized as a tablet computer 10. The tablet computer 10 is a portable electronic device referred to as a tablet or slate computer. The tablet computer 10 comprises a body 11 and a touch screen display 12 as shown in FIG. 1. The body 11 comprises a housing shaped in a thin box. The touch screen display 17 is mounted on the body 11 so as to overlay the upper surface of the body 11.

A flat panel display and a sensor are built in the touch screen display 17. The sensor is configured to detect a touch position of the pen or the finger on a screen of the flat panel display. The flat panel display may be, for example, a liquid crystal display (LCD). As the sensor, for example, a capacitive touch panel, an electromagnetic induction digitizer or the like can be used. It is hereinafter assumed that two types of sensors, a digitizer and a touch panel, are incorporated in the touch screen display 17.

The digitizer is arranged on, for example, the lower side of the screen of the flat panel display. The touch panel is arranged on, for example, the screen of the flat panel display. The touch screen display 17 can detect not only a touch operation on the screen with a finger, but also a touch operation on the screen with a pen 100. The pen 100 may be, for example, a digitizer pen (electromagnetic induction pen). The user can execute a handwriting input operation on the touch screen display 17 using an external object (the pen 100 or a finger). During the handwriting input operation, a locus of movement of the external object (pen 100 or finger) on the screen, i.e., a locus of the stroke input by handwriting is drawn in real time, and the locus of each stroke is thereby displayed on the screen. The locus of movement of the external object which is made while the external object is in touch with the screen corresponds to one stroke (one handwritten stroke). A set of strokes corresponding to handwritten characters or handwritten figures, that is, a set of a number of loci (handwriting), constitutes a handwritten document.

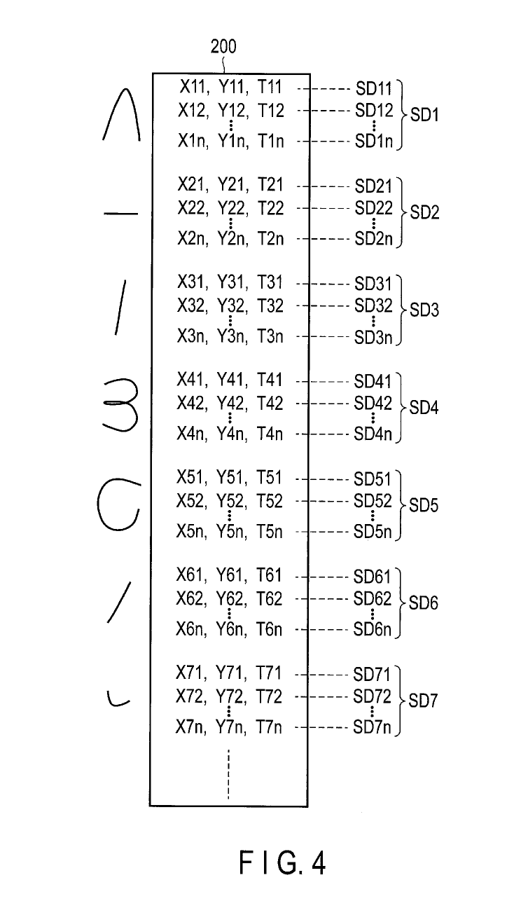

In the present embodiment, the handwritten document is stored in a storage medium as not image data, but time-series information indicating both coordinate string of the locus of each stroke and an order relationship between the strokes. The time-series information, which will be described later in detail with reference to FIG. 4, indicates the order in which plural strokes have been handwritten, and includes plural stroke data elements corresponding to the plural strokes, respectively. In other words, the time-series information means a set of time-series stroke data elements corresponding to the plural strokes, respectively. Each stroke data element corresponds to a stroke and includes a coordinate data series (time-series coordinates) corresponding to each of the points on the locus of the stroke. The order of arrangement of the stroke data elements corresponds to the order in which the strokes were made, in other words, the writing order.

The tablet computer 10 can read an arbitrary existing time-series information (handwritten document data) from the storage medium and display a handwritten document corresponding to the time-series information, that is, loci corresponding to the plural strokes presented by the time-series information, respectively, on the screen. The tablet computer 10 further comprises an edit function. The edit function can delete or move an arbitrary stroke, an arbitrary handwritten character or the like in a currently displayed handwritten document, in accordance with an edit operation by the user using an “eraser” tool, a “range selection” tool, other various tools and the like. Furthermore, the edit function also includes a function of undoing a history of several handwriting operations.

Furthermore, tablet computer 10 also has a handwriting suggestion (handwriting-complete) function. The handwriting function is a function of assisting the user's handwriting input operation to enable a number of strokes to be easily input by handwriting.

FIG. 2 shows an example of the cooperation between the tablet computer 10 and an external device. The tablet computer 10 can cooperate with the personal computer 1 or a cloud. In other words, the tablet computer 10 comprises a wireless communication device such as a wireless LAN and is capable of wirelessly communicating with the personal computer 1. Furthermore, the tablet computer 10 can also communicate with a server 2 on the Internet. The server 2 may be a server which provides on-line storage services or other various cloud computing services.

The personal computer 1 comprises a storage device such as a hard disk drive (HDD). The tablet computer 10 can transmit time-series information (handwritten document) to the personal computer 1 via a network and record the time-series information in the HDD of the personal computer 1 (in an upload operation).

This enables the tablet computer 10 to handle a large number of elements of time-series information (handwritten document) or a large amount of time-series information (handwritten document) even when the capacity of the storage in the tablet computer 10 is low.

Furthermore, the tablet computer 10 can read at least one arbitrary handwritten document recorded in the HDD of the personal computer 1 (in a download operation). The tablet computer 10 can display a locus of each of the strokes represented by the handwritten document thus read, on the screen of the touch screen display 17 of the tablet computer 10. In this case, a list of thumbnails obtained by reducing each page of plural handwritten documents may be displayed on the screen of the touch screen display 17 or one page selected from the thumbnails may be displayed in a normal size on the screen of the touch screen display 17.

Moreover, a destination with which the tablet computer 10 communicates may not be the personal computer 1, but may be the server 2 on the cloud which provides storage services and the like as explained above. The tablet computer 10 can transmit the handwritten document to the server 2 via a network and record the handwritten document in the storage device 2A of the server 2 (in an upload operation). Furthermore, the tablet computer 10 can read any handwritten document recorded in the storage device 2A of the server 2 (in a download operation). The tablet computer 10 can display a locus of each of the strokes represented by the handwritten document thus read, on the screen of the touch screen display 17 of the tablet computer 10.

Thus, in the present embodiment, a storage medium on which the handwritten document is stored may be any one of the storage device in the tablet computer 10, the storage device in the personal computer 1 and the storage device of the server 2.

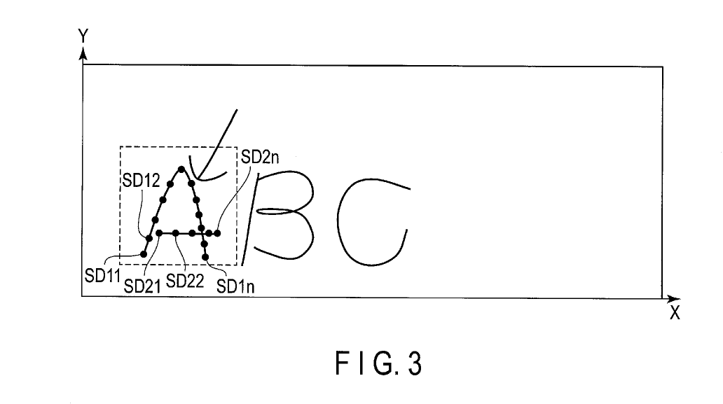

Next, a relationship between strokes (characters, marks, figures (diagrams), tables, and the like) handwritten by the user and the handwritten document will be explained with reference to FIG. 3 and FIG. 4. FIG. 3 shows an example of a handwritten character string handwritten on the touch screen display 17 with the pen 100 or the like.

In a handwritten document, another character, figure or the like is often handwritten over an already handwritten character, figure or the like. In FIG. 3, it is assumed that a handwritten character string “ABC” is handwritten in order of “A”, “B”, and “C” and that after this, a handwritten arrow is handwritten very closely to the handwritten character “A”.

The handwritten character “A” is represented by two strokes (a “´”-shaped locus and a “-”-shaped locus) handwritten with the pen 100 or the like, that is, by two loci. The “´”-shaped locus first handwritten with the pen 100 is sampled in real time at equal time intervals, and time-series coordinates SD11, SD12, . . . , SD1n of the “´”-shaped stroke can be thereby obtained. Similarly, the “-”-shaped locus next handwritten with the pen 100 is also sampled in real time at equal time intervals, and time-series coordinates SD21, SD21, . . . , SD2n of the “-”-shaped stroke can be thereby obtained.

The handwritten character “B” is represented by two strokes handwritten with the pen 100 or the like, that is, by two loci. The handwritten character “C” is represented by one stroke handwritten with the pen 100 or the like, that is, by one locus. The handwritten arrow is represented by two strokes handwritten with the pen 100 or the like, that is, by two loci.

FIG. 4 shows time-series information 200 corresponding to the handwritten character string shown in FIG. 3. The time series information 200 includes plural elements of stroke data SD1, SD2, . . . , the SD7. In the time-series information 200, the elements of stroke data SD1, SD2, . . . , SD7 are arranged in order of handwriting, that is, chronologically in the order in which plural strokes have been handwritten.

In the time-series information 200, the first two stroke data elements SD1 and SD2 represent the two strokes of the handwritten character “A”, respectively. Third and fourth stroke data elements SD3 and SD4 represent the two strokes constituting the handwritten character “B”, respectively. A fifth stroke data element SD5 represents one stroke constituting the handwritten character “C”. Sixth and seventh stroke data elements SD6 and SD7 represent two strokes constituting the handwritten arrow, respectively.

Each stroke data element includes a coordinate data series (time-series coordinates) corresponding to one stroke, that is, plural coordinates corresponding to plural points on a locus of the stroke, respectively. In each stroke data element, the plural coordinates are arranged chronologically in the order in which the stroke has been written. For example, as for the handwritten character “A”, the stroke data element SD1 includes coordinate data series (time-series coordinates) corresponding to the points on the locus of the “´”-shaped stroke of the handwritten character “A”, that is, n coordinate data elements SD11, SD12, . . . , SD1n. The stroke data element SD2 includes coordinate data series corresponding to the points on the locus of the “-”-shaped stroke of the handwritten character “A”, that is, n coordinate data elements SD21, SD22, . . . , SD2n. The number of coordinate data elements may differ for each stroke data element. That is, since the locus of the pen 100 is sampled in real time at equal time intervals, the number of coordinate data is increased as the stroke is longer or as the handwriting speed of the stroke is slower.

Each coordinate data element represents an X-coordinate and a Y-coordinate corresponding to a point in the corresponding locus. For example, the coordinate data element SD11 represents X-coordinate (X11) and Y-coordinate (Y11) of the start point of the “´”-shaped stroke. SD1n represents the X-coordinate (X1n) and the Y-coordinate (Yin) of the end point of the “´”-shaped stroke.

Furthermore, each coordinate data element may include time stamp information T corresponding to a time at which a point corresponding to the coordinates has been handwritten. Moreover, information (Z) indicating a writing pressure may be added to each coordinate data element.

Moreover, in the present embodiment, since a handwritten document is stored as a set of time-series stroke data elements, not images or character recognition results, as explained above, handwritten characters can be handled independently of the language of the handwritten characters. The structure of the time-series information 200 in the present embodiment can be therefore used in the same manner in various countries differing in language around the world.

FIG. 5 shows a system configuration of the tablet computer 10.

As shown in FIG. 5, the tablet computer 10 comprises a CPU 101, a system controller 102, a main memory 103, a graphics controller 104, a BIOS-ROM 105, a nonvolatile memory 106, a wireless communication device 107, an embedded controller (EC) 108, and the like.

The CPU 101 is a processor (hardware processor) which controls the operations of various components in the tablet computer 10. The CPU 101 executes various computer programs loaded from the non-volatile memory 106 serving as a storage device to the main memory 103. These programs include an operating system (OS) 201 and various application programs. The application programs include a handwritten notebook application program 202. The handwritten notebook application program 202 has a function of creating and displaying the above-explained handwritten document, a function of editing a handwritten document, a handwriting suggestion function, and the like.

In addition, the CPU 101 also executes a Basic Input/Output System (BIOS) stored in the BIOS-ROM 105. The BIOS is a program for hardware control.

The system controller 102 is a device which makes connection between a local bus of the CPU 101 and various components. The system controller 102 incorporates a memory controller which controls access to the main memory 103. In addition, the system controller 102 also has the function of communicating with the graphics controller 104 via a serial bus conforming to the PCI EXPRESS standard, or the like.

The graphics controller 104 is a display controller which controls the LCD 17A used as a display monitor of the tablet computer 10. A display signal generated by the graphics controller 104 is sent to the LCD 17A. The LCD 17A displays a screen image, based on the display signal. On the LCD 17A, a touch panel 17B and a digitizer 17C are arranged. The touchpanel 17B is a capacitive pointing device for inputting data on the screen of the LCD 17A. The touchpanel 17B detects the contact position of a finger on the screen, the movement of the contact position, etc. The digitizer 17C is an electromagnetic induction type of pointing device for inputting data via the screen of the LCD 17A. The digitizer 17C detects the contact position of the pen 100 on the screen, the movement of the contact position, etc.

The wireless communication device 107 is a device configured to perform wireless communication such as wireless LAN, 3G mobile communication or the like. The EC 108 is a single-chip microcomputer comprising an embedded controller for power management. The EC 108 has a function of turning the tablet computer 10 on and off in accordance with a user's operation on a power button.

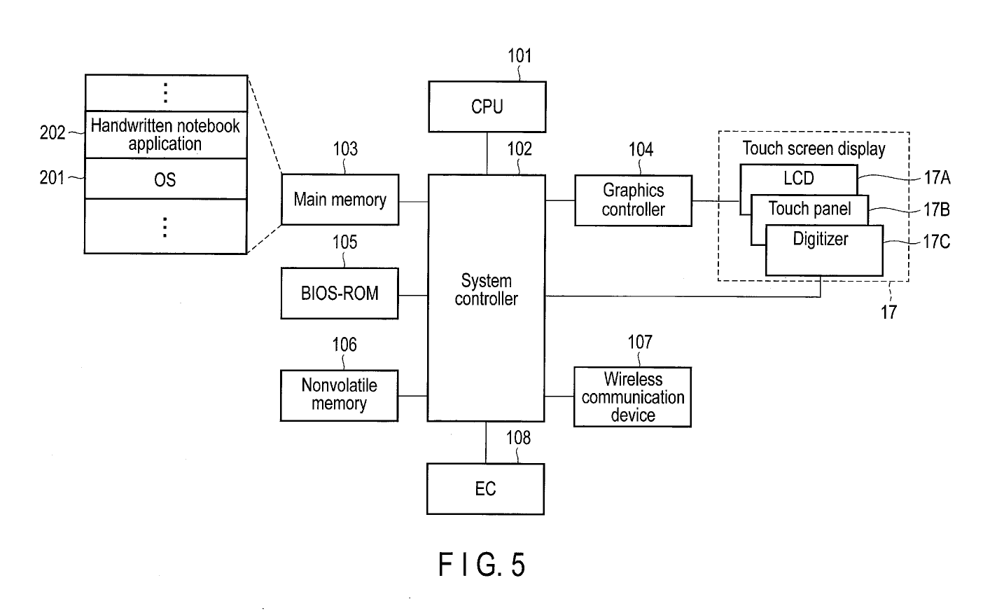

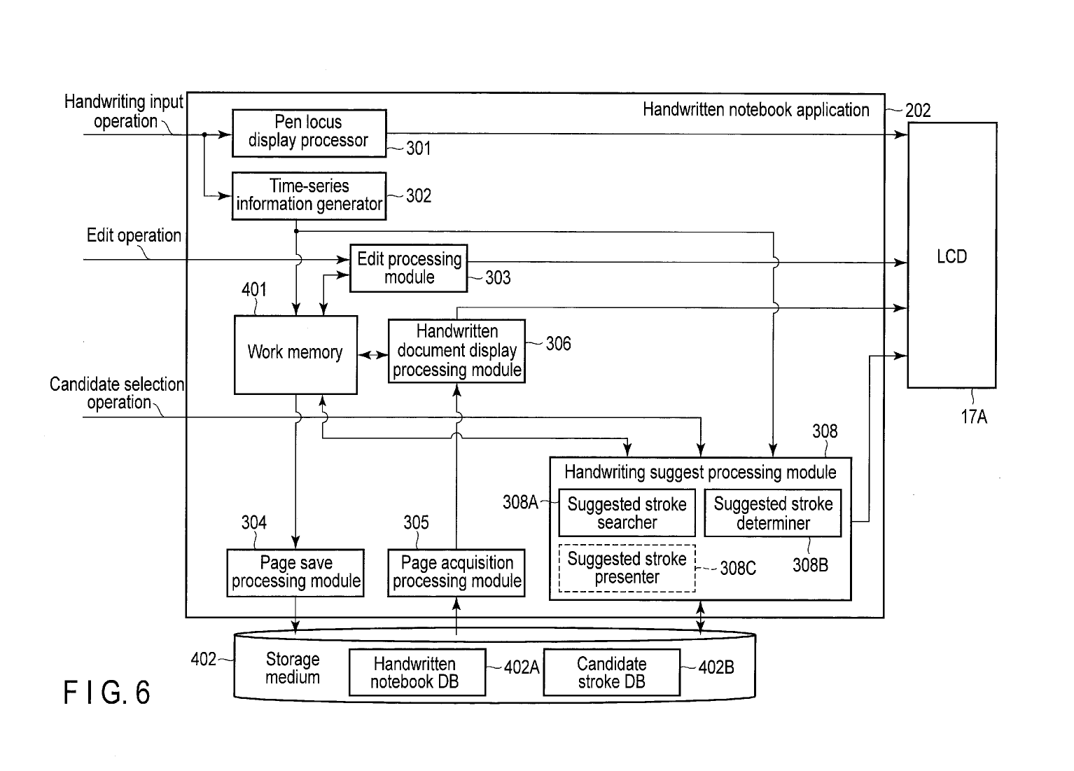

Next, a functional configuration of the handwritten notebook application program 202 will be explained with reference to FIG. 6.

The handwritten notebook application program 202 comprises a pen locus display processing module 301, a time-series information generator 302, an edit processing module 303, a page save processing module 304, a page acquisition processing module 305, a handwritten document display processing module 306, a handwriting suggest processing module 308, and the like.

The handwritten notebook application program 202 creates, displays and edits a handwritten document (handwritten data) by using stroke data input with the touch screen display 17. The touchscreen display 17 is capable of detecting a stroke made on the screen of the touchscreen display 17 and displaying the stroke on the screen. The touch screen display 17 is configured to detect the occurrence of an event such as “touch”, “move (slide)”, or “release”. “Touch” is an event indicating that an external object has made contact with the screen. “Move (slide)” is an event indicating that the contact position has been moved while an external object is in contact with the screen. “Release” is an event indicating that an external object has been separated from the screen. The handwritten note application program 202 displays a document such as the handwritten document and other electronic documents on the screen.

The pen locus display processing module 301 and the time-series information generator 302 receive the “touch” or “move (slide)” event generated by the touch screen display 17, thereby detecting a handwriting input operation. The “touch” event includes the coordinates of the contact position. The “move (slide)” event also includes coordinates of a contact position of a move destination. The pen locus display processing module 301 and the time-series information generator 302 can therefore receive a coordinate string corresponding to the locus of the movement of the contact position from the touch screen display 17.

The pen locus display processing module 301 functions as a display processing module configured to receive a stroke made on a document (e.g., handwritten page) displayed on the screen of the touch screen display 17, and to display the stroke on the document (e.g., handwritten page). The pen locus display processing module 301 receives the coordinate strings from the touch screen display 17. Then, based on the coordinate strings, the pen locus display processing module 301 displays plural strokes handwritten by the handwriting input operation using the pen 100 or the like on the screen of the LCD 17A in the touch screen display 17.

The time-series information generator 302 receives the above-explained coordinate strings output from the touch screen display 17. The time-series information generator 302 generates plural stroke data elements (time-series information) corresponding to the plural strokes, based on the coordinate strings. These stroke data elements, that is, the coordinates corresponding to the respective points of each stroke may be stored temporarily in a work memory 401.

The page save processing module 304 stores the time-series information including the plural stroke data elements corresponding to the plural strokes, in a handwritten notebook database 402A in a storage medium 402. As explained above, the storage medium 402 may be any one of the storage device in the tablet computer 10, the storage device in the personal computer 1, and the storage device of the server 2.

The page acquisition processing module 305 reads arbitrary handwritten document data from the storage medium 402. The read handwritten document data is sent to the handwritten document display processing module 306. The handwritten document display processing module 306 analyzes the handwritten document data and displays loci of the plural strokes indicated by the plural stroke data elements in the handwritten document data as a handwritten page, on the screen, based on the analysis result.

The edit processing module 303 executes processing for editing a currently displayed document (i.e., a handwritten page). In other words, the edit processing module 303 executes edit processing for erasing or moving at least one stroke of the plural displayed strokes, in accordance with the edit operation executed on the touch screen display 17 by the user. Furthermore, the edit processing module 303 updates the handwritten document to reflect a result of the edit processing on the displayed handwritten document.

The user can erase an arbitrary stroke in the plural strokes currently displayed, by the “eraser” tool or the like. In addition, the user can select a range of an arbitrary portion in the handwritten page currently displayed, by using a “range selection” tool to surround an arbitrary portion on the screen by a circle or a square.

The handwriting suggest processing module 308 is a processing module configured to execute the above-explained handwriting suggestion function. In the handwriting suggestion processing, the handwriting suggest processing module 308 acquires the stroke string (handwriting candidate) corresponding to at least one stroke input by handwriting, from a set of previously input strokes (handwritten document data). The handwriting suggest processing module 308 recommends the acquired stroke string to the user by displaying the acquired stroke string on the screen.

In other words, the handwriting suggest processing module 308 predicts the stroke string which the user is to handwrite (for example, a handwritten character string, a handwritten figure or the like), based on the at least one input stroke and the handwritten document data. Then, the handwriting suggest processing module 308 executes processing for displaying the stroke string obtained by the prediction as a suggested stroke string (handwriting candidate), on the screen.

For example, if a stroke “a” is input by handwriting, the previously input stroke string starting with the stroke “a”, for example, a handwritten word “access” is displayed as a suggested stroke string (handwriting candidate). If an operation to adopt the handwritten word “access” as an input stroke, for example, an operation to input a stroke to a position following the handwritten word “access” by handwriting or the like is executed by the user, the handwritten word “access” is adopted as an input (an input stroke) and handled as an entered handwritten character string.

The suggested stroke string is not limited to the handwritten word, but may also be a handwritten phrase. For example, if a stroke “J” is input by handwriting, a stroke string of the previously input handwritten character string “January 13, 2014” may be displayed as a suggested stroke string (handwriting candidate).

In the handwriting suggestion processing, one or more handwriting candidates corresponding to at least one stroke which is input by handwriting may be presented to the user. In this case, for example, if a stroke (handwritten character string) “a” is input by handwriting, a list of several handwriting candidates such as handwritten words “add” and “access” may be presented to the user. If the handwritten word “access” is selected by the user, the selected handwritten word “access” is adopted as the input and handled as the input handwritten character string. That is, the handwritten word “access” is entered to the page.

Example of the stroke string corresponding to at least one input stroke is the plural strokes including a stroke similar to the at least one input stroke. The handwriting suggest processing module 308 searches the handwritten document data for a stroke string corresponding to the at least one input stroke.

To enable the stroke string corresponding to the at least one input stroke to be easily acquired from the handwritten document data, the handwriting suggest processing module 308 may generate a candidate stroke database 402B, based on a set of strokes (handwritten document data) stored in the handwritten notebook database 402A.

The candidate stroke database 402B may comprise plural entries that correspond to plural types of character strings, respectively. Each of the entries may store a stroke string (stroke data group) corresponding to the character string of this entry.

In this case, first, the handwriting suggest processing module 308 may recognize at least one stroke which is input by the user as the character. The handwriting suggest processing module 308 finds a character string whose prefix agrees with the result of character recognition (the character string) of the at least one input stroke by referring to the candidate stroke database 402B. The handwriting suggest processing module 308 acquires the stroke string corresponding to the found character string as the stroke string corresponding to the at least one input stroke, from the candidate stroke database 402B.

Alternatively, each entry in the candidate stroke database 402B may store the stroke string (stroke data group) corresponding to the character string of the entry, and a feature amount of each stroke in the stroke string. For the feature amount of a stroke, an arbitrary feature which can indicate the handwriting feature of the stroke may be used. For example, for the feature amount, the data of feature amount indicating the form of the stroke, the writing direction of the stroke or the inclination of the stroke may be used. In this case, the handwriting suggest processing module 308 may acquire a stroke string having a feature amount similar to the feature amount of the at least one input stroke from the candidate stroke database 402B.

The handwriting suggest processing module 308 comprises a suggested stroke searcher 308A and a suggested stroke determiner 308B. The suggested stroke searcher 308A searches for the stroke string corresponding to the at least one input stroke by referring to the candidate stroke database 402B. The searched stroke string is displayed on the screen as a suggested stroke string (handwriting candidate).

The suggested stroke determiner 308B executes processing for adopting a portion of the suggested stroke string (a portion of handwriting candidate) as an input. It is assumed here that at least one first stroke which is input by handwriting is displayed on the screen. The suggested stroke searcher 308A displays on the screen the suggested stroke string (handwriting candidate) corresponding to the at least one first stroke. The suggested stroke string (handwriting candidate) is acquired from the handwritten document data (candidate stroke database 402B). The suggested stroke string is a previously input stroke string. The suggested stroke string includes plural strokes. In other words, the suggested stroke string includes at least one stroke (second stroke), and the other at least one stroke (third stroke) subsequent to the at least one second stroke. If at least one new stroke (fourth stroke) is input by handwriting in an area corresponding to the at least one third stroke, the suggested stroke determiner 308B executes processing of adopting the at least one second stroke as an input and not adopting the at least one third stroke as an input. That is, the suggested stroke determiner 308B enters the at least one second stroke of the suggested stroke string (handwriting candidate) to the page, and does not enter the at least one third stroke of the suggested stroke string (handwriting candidate) to the page.

Thus, the portion (at least one third stroke) overwritten by the at least one new stroke (fourth stroke), of the suggested stroke string, is not adopted as an input. Then, the at least one second stroke alone, of the suggested stroke string, is adopted as an input.

Furthermore, the at least one stroke (fourth stroke) which is input on the unadopted portion of the suggested stroke string may be used as base strokes for displaying a next suggested stroke string. In other words, a new suggested stroke string corresponding to the at least one fourth stroke may be displayed on the screen.

Thus, in the present embodiment, only a portion preceding a portion which is to be unadopted, of the suggested stroke string (handwriting candidate), can easily be adopted as an input by merely inputting a new handwritten stroke on the portion which is to be unadopted in the displayed suggested stroke string (handwriting candidate).

The handwriting suggest processing module 308 may further comprise a suggested stroke presenter 308C. The suggested stroke presenter 308C presents one or more handwriting candidates corresponding to at least one stroke which is input by handwriting by the user. If one of the handwriting candidates is selected by the user, the selected handwriting candidate is displayed on the screen as the above-explained suggested stroke string.

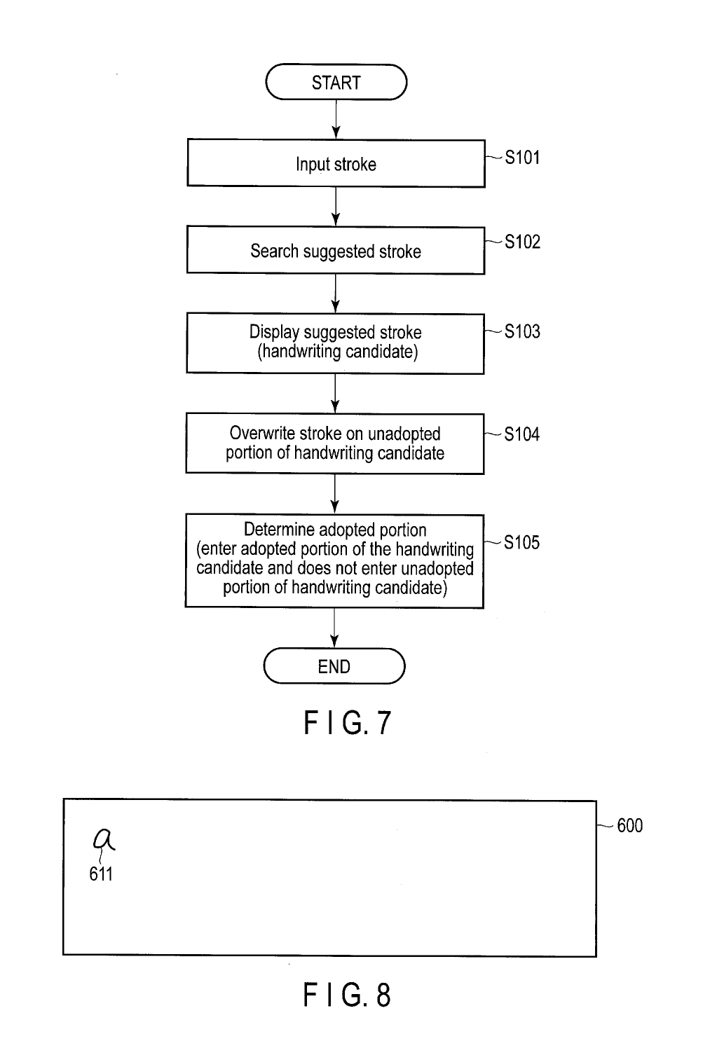

The flowchart of FIG. 7 shows steps of handwriting suggestion processing.

The handwritten notebook application program 202 displays on the editing screen a document (e.g., handwritten page) stored in a memory such as the storage medium 402a. When the stroke is input by the handwriting input operation which is executed on the edit screen (step S101), the pen locus display processing module 301 receives the input stroke made on the document displayed on the screen and displays the input stroke on the editing screen. The handwriting suggest processing module 308 searches for the stroke string (handwriting candidate) corresponding to the input stroke by referring to the candidate stroke database 402B (step S102).

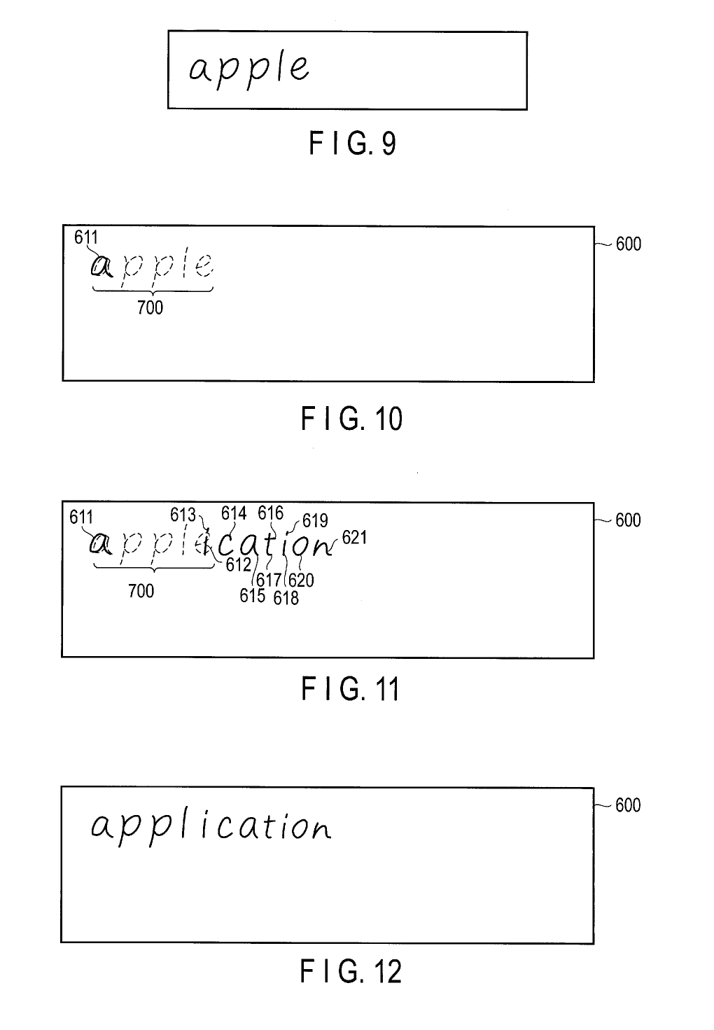

It is assumed that, for example, the user is to input a handwritten character string “application” by handwriting. The handwritten character string “apple” has been already stored in the candidate stroke database 402B. When a stroke 611 corresponding to the character “a” is input on the edit screen 600 by handwriting as shown in FIG. 8, the handwriting suggest processing module 308 searches for the handwritten character string “apple” shown in FIG. 9 as a suggested stroke string (handwriting candidate) by referring to the candidate stroke database 402B. Then, the handwriting suggest processing module 308 displays the handwritten character string “apple” on the edit screen 600 (step S103).

In step S103, the handwriting suggest processing module 308 displays the suggested stroke string “apple” 700 at a position corresponding to the stroke “a” 611, as shown in FIG. 10. In this case, the suggested stroke string “apple” 700 may be displayed such that the leading portion “a” of the suggested stroke string “apple” overlaps with an area where the stroke 611 is written. At this time, since the suggested stroke string 700 has not yet been determined as an input, that is, since the suggested stroke string 700 has not yet been entered in to the document (e.g., handwritten page), the suggested stroke string 700 is displayed in a style different from a style of the entered stroke. For example, if the stroke 611 is input by the handwriting input operation in a state in which a current pen color is set to black, the stroke 611 is displayed in black. In contrast, the suggested stroke string 700 may be displayed in a color different from black, for example, gray which is lighter than black. Alternatively, the suggested stroke string 700 may be displayed in a color different from black, for example, red. Alternatively, transparency of the suggested stroke string 700 may be set to be high so as to enable the stroke 611 to be seen through the suggested stroke string 700. It is assumed in FIG. 10 that the suggested stroke string 700 is displayed thickly in gray and that the transparency of each gray stroke is set to be high. The gray stroke is shown in broken lines in FIG. 10. It can be thereby understood that the suggested stroke string 700 is different from the stroke input by handwriting.

The user starts writing strokes 612 to 621 of a handwritten character string “ication” so as to overlap an area corresponding to “e” in the displayed suggested stroke string 700, in step S104 (FIG. 11). The handwriting suggest processing module 308 receives the strokes 612 to 621 made on the edit screen. The handwriting suggest processing module 308 determines that a position where the handwritten character string “ication” is written overlaps with “e” in the suggested stroke string 700 and is behind “e” in the suggested stroke string 700. The position where the handwritten character string “ication” is written may be determined by, for example, “overlap judgment” method of determining whether a certain handwritten stroke and another handwritten stroke overlap each other. Overlap determination between strokes can be performed in various methods. For example, the handwriting suggest processing module 308 may calculate a circumscribed rectangle of “e” and a circumscribed rectangle of “i” to be input. Then, if the circumscribed rectangles overlap at a rate higher than or equal to a certain threshold value, the handwriting suggest processing module 308 may determine that “e” and “i” overlap.

Then, in step S105, the handwriting suggest processing module 308 determines “e” in the suggested stroke string 700 as the unadopted portion which is not adopted as the input, and determines “appl” in the suggested stroke string 700 as the adopted portion which is adopted as the input. The handwriting suggest processing module 308 adopts “appl” in the suggested stroke string 700 as the input. That is, the handwriting suggest processing module 308 enters the adopted portion “appl” of the suggested stroke string (handwriting candidate) 700 and the handwritten character string “ication” into the document, and does not enter the unadopted portion “e” of the suggested stroke string (handwriting candidate) 700 into the document. In this case, the stroke “a” 611 may be replaced by “appl” in the suggested stroke string 700 or “ppl” in the suggested stroke string 700 may be added after the stroke “a” 611. “appl” is displayed in the same style (color, thickness, transparency, and pen type) as the style of the strokes which are currently input. The unadopted portion “e” in the suggested stroke string 700 is not adopted as the input. The unadopted portion “e” is deleted and disappears from the edit screen 600, and a handwritten character string “application” is displayed as shown in FIG. 12. The handwritten character string “application” includes the completed handwritten character string “appl” and the handwritten character string “ication” which is input by handwriting.

If the displayed suggested stroke string 700 is different from the stroke string which the user wishes to input, the user may continue writing the stroke string while ignoring the suggested stroke string.

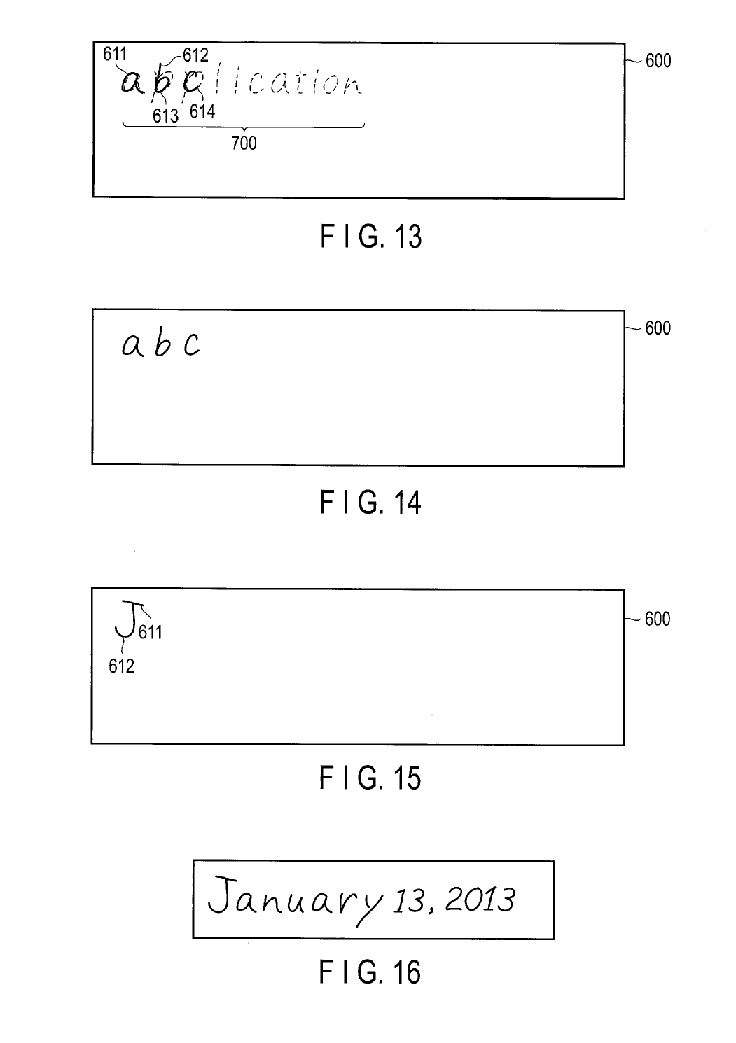

It is assumed that, on the edit screen 600 in FIG. 13, the stroke 611, which is the handwritten letter “a”, is input by the user and the previously input stroke string “application” is displayed as a suggested stroke string (handwriting candidate) corresponding to the handwritten character “a”.

If the character string which is to be written is not “application” but “abc”, the user may input the strokes 612 to 614 corresponding to the handwritten character string “bc”, by handwriting, on an area corresponding to “pp” of the displayed suggested stroke string “application”, as shown in FIG. 13. The entire suggested stroke string 700 is not thereby adopted, and the entire suggested stroke string is deleted and disappears (FIG. 14). Inputting the strokes 612 to 614 in the area corresponding to “pp” by handwriting is the same as writing “bc” after “a”. Thus, the entire body of the displayed suggested stroke string 700 can be unadopted by continuing writing while ignoring the suggested stroke string 700.

Next, another example of the processing of partially adopting the suggested stroke string will be explained.

It is assumed here that the user is to input a handwritten character string “January 13, 2014”. It is also assumed that a handwritten character string “January 13, 2013” has already been stored in the candidate stroke database 402B.

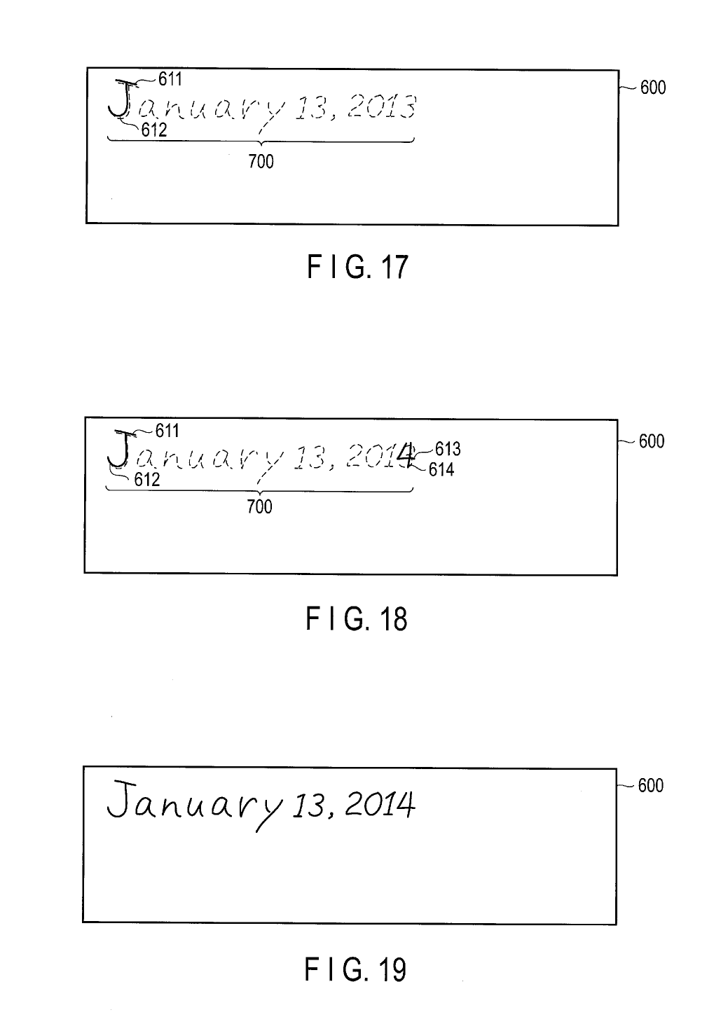

When the strokes 611 and 612 corresponding to a handwritten character “J” are input by handwriting on the edit screen 600 as shown in FIG. 15, the handwriting suggest processing module 308 searches the handwritten character string “January 13, 2013” shown in FIG. 16 as a suggested stroke string by referring to the candidate stroke database 402B. As shown in FIG. 17, the handwriting suggest processing module 308 displays the handwritten character string “January 13, 2013” as a suggested stroke string (handwriting candidate) 700, on the edit screen 600.

The suggested stroke string “January 13, 2013” may be displayed such that a leading part “J” of the suggested stroke string “January 13, 2013” 700 overlaps with an area corresponding to the “J” which has been input by handwriting.

The user starts writing strokes 613 to 614 of a handwritten character string “4” such that the handwritten character string overlaps an area corresponding to “3” in the displayed suggested stroke string 700 (FIG. 18). The handwriting suggest processing module 308 determines that a position where the handwritten character string “4” is written is at “3” in the suggested stroke string 700. Then, the handwriting suggest processing module 308 executes processing of adopting “January 13, 201” in the suggested stroke string 700 as an input and not adopting “4” in the suggested stroke string 700 as an input. The adopted portion “January 13, 201” in the suggested stroke string 700 and the strokes 613, 614 of the handwritten character string “4” are entered in to the document, and the unadopted portion “3” in the suggested stroke string 700 is not entered. In other words, the strokes 611 and 612 corresponding to “J” are completed with the adopted portion “January 13, 201” in the suggested stroke string 700. In this case, the strokes 611 and 612 of “J” may be replaced by the adopted portion “January 13, 201”. The adopted portion “January 13, 201” is displayed in the same style as the style of the stroke which is being input. Then, the unadopted portion “3” in the suggested stroke string 700 is deleted and disappears from the edit screen 600, and the handwritten character string “January 13, 2014” including the completed handwritten character string “January 13, 201” and the handwritten character string “4” which is written on the “3” is displayed as shown in FIG. 19.

Next, yet another example of the processing of partially adopting the suggested stroke string will be explained.

It is assumed here that the user is to input a handwritten character string “I like soccer”. It is also assumed that a handwritten character string “I like baseball” has already been stored in the candidate stroke database 402B.

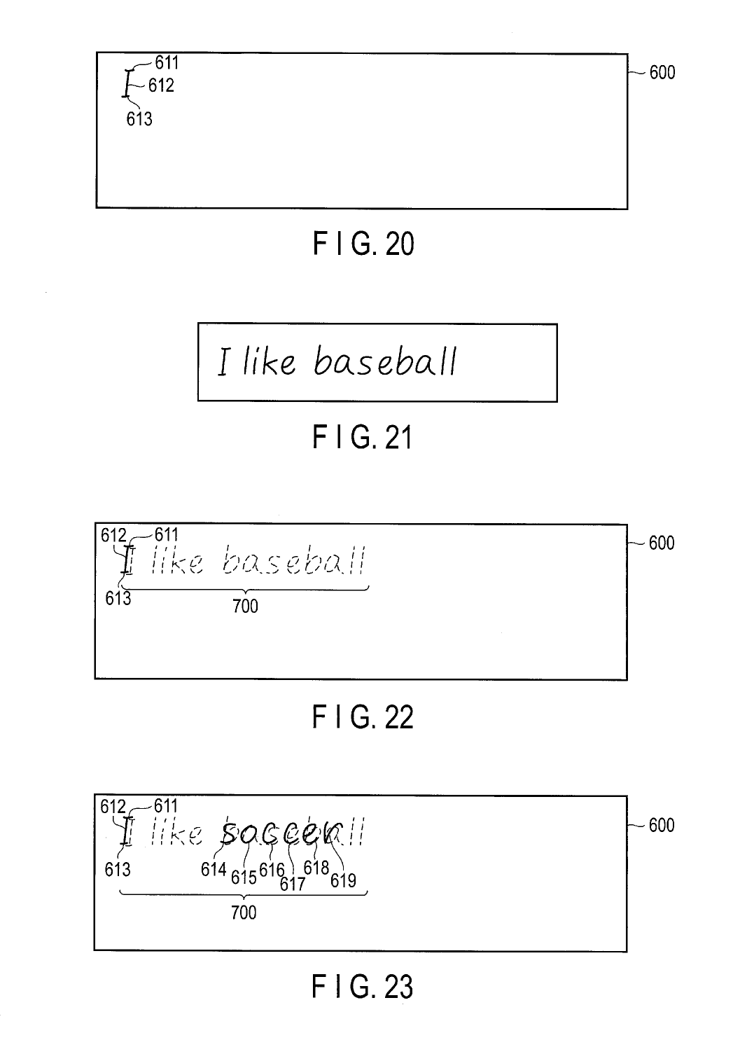

When strokes 611 to 613 corresponding to a handwritten character “I” are input by handwriting on the edit screen 600 as shown in FIG. 20, the handwriting suggest processing module 308 searches the handwritten character string “I like baseball” shown in FIG. 21 as a suggested stroke string by referring to the candidate stroke database 402B. As shown in FIG. 22, the handwriting suggest processing module 308 displays the handwritten character string “I like baseball” as a suggested stroke string (handwriting candidate) 700, on the edit screen 600.

The suggested stroke string “I like baseball” may be displayed such that a leading part “I” of the suggested stroke string “I like baseball” 700 is overlaps with an area corresponding to the input strokes 611 to 613.

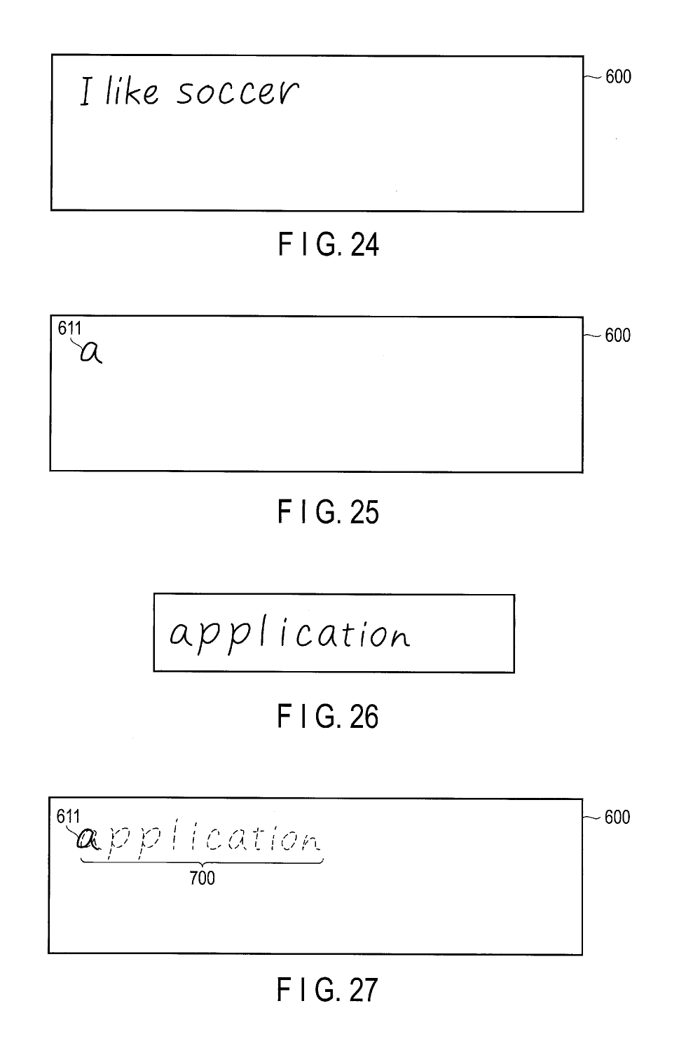

The user starts writing strokes 614 to 619 of a handwritten character string “soccer” such that the handwritten character string overlaps an area corresponding to “baseball” in the displayed suggested stroke string 700 (FIG. 23). The handwriting suggest processing module 308 determines that a position where the handwritten character string “soccer” is written is at “baseball” in the suggested stroke string 700. Then, the handwriting suggest processing module 308 executes processing of adopting “I like” in the suggested stroke string 700 as an input and not adopting “baseball” in the suggested stroke string 700 as an input. The adopted portion “I like” in the suggested stroke string 700 and the strokes 614 to 619 of the handwritten character string “soccer” are entered into the document, and the unadopted portion “baseball” in the suggested stroke string 700 is not entered. In other words, the strokes 611 to 613 corresponding to “I” are completed with the adopted portion “I like” in the suggested stroke string 700. In this case, the strokes 611 to 613 of “I” may be replaced by the adopted portion “I like”. The adopted portion “I like” is displayed in the same style as the style of the stroke which is being input. Then, the unadopted portion “baseball” in the suggested stroke string 700 is deleted and disappears from the edit screen 600, and the handwritten character string “I like soccer” including the completed handwritten character string “I like” and the handwritten character string “soccer” which is written on the “baseball” is displayed as shown in FIG. 24.

Next, processing of using a stroke of a predetermined shape which is input by handwriting and making a part or an entire body of a suggested stroke string unadopted will be explained.

For example, a stroke corresponding to a lateral line “-” may be used as a stroke of a predetermined shape. The stroke corresponding to a lateral line “-” is a stroke to designate an unadopted portion in a suggested stroke string. The stroke corresponding to a lateral line “-” is used as a stroke to enable a part or an entire body of a suggested stroke string to be deleted even if no more characters need to be written.

It is assumed here that the user is to input a handwritten character string “app”. It is also assumed that a handwritten character string “application” has already been stored in the candidate stroke database 402B.

When a stroke 611 corresponding to a character “a” is input by handwriting on the edit screen 600 as shown in FIG. 25, the handwriting suggest processing module 308 searches the handwritten character string “application” shown in FIG. 26 as a suggested stroke string by referring to the candidate stroke database 402B. As shown in FIG. 27, the handwriting suggest processing module 308 displays the handwritten character string “application” as a suggested stroke string (handwriting candidate) 700, on the edit screen 600.

As shown in FIG. 27, the suggested stroke string “application” 700 may be displayed such that a leading part “a” of the suggested stroke string “application” 700 overlaps with an area where the stroke 611 is written.

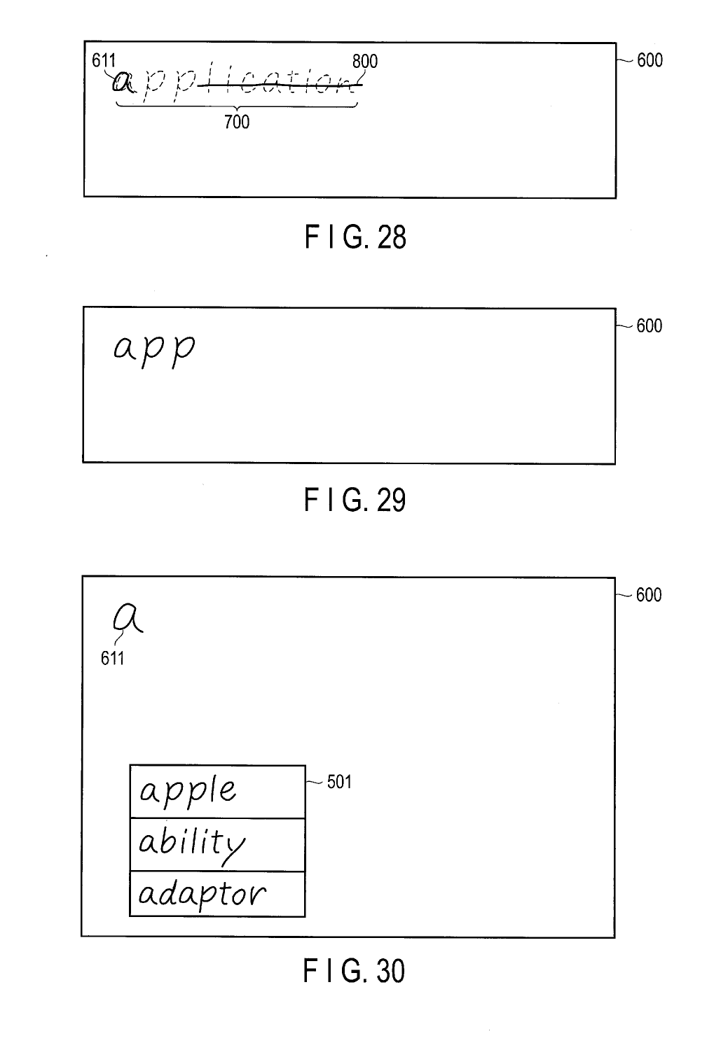

The user starts writing a stroke “-” 800 such that the stroke overlaps an area corresponding to “lication” in the displayed suggested stroke string 700 (FIG. 28). The handwriting suggest processing module 308 determines that a position where the stroke “-” 800 is written is at the area corresponding to “lication” in the suggested stroke string 700. The handwriting suggest processing module 308 determines that the area (“lication”) where the stroke “-” 800 is input should be unadopted.

Then, the handwriting suggest processing module 308 adopts “app” in the suggested stroke string 700 as an input and deletes “lication” in the suggested stroke string 700 and the stroke “-” 800 input by handwriting. Thus, “lication” in the suggested stroke string 700 and the stroke “-” 800 input by handwriting disappear from the edit screen 600.

In other words, the stroke 611 corresponding to “a” is completed with the adopted portion “app” in the suggested stroke string 700. In this case, the stroke “a” 611 may be replaced by the adopted portion “app”. The adopted portion “app” is displayed in the same style as the style of the stroke which is being input. Then, the unadopted portion “lication” in the suggested stroke string 700 and the stroke “-” 800 are deleted, and the completed handwritten character string “app” alone is displayed as shown in FIG. 29.

If the stroke “-” 800 is input by handwriting on “p” or “pp” of the suggested stroke string 700, the entire body of the suggested stroke string 700 is unadopted. Then, the entire body of the suggested stroke string 700 and the stroke “-” 800 are deleted and disappear from the edit screen 600. This matter is the same as writing nothing after “a”.

In addition, if the stroke “-” 800 is input by handwriting on “a” or “app” of the suggested stroke string 700, the entire body of the suggested stroke string 700 may also be unadopted.

The stroke “-” 800 which is written on a part of the suggested stroke string 700 is not used as a stroke handled as a base of handwriting suggestion. A suggested stroke string corresponding to the stroke “-” 800 is not therefore displayed.

If the stroke “-” 800 is input by handwriting on an area which does not overlap the suggested stroke string 700, the stroke “-” 800 is handled similarly to the other general stroke.

FIG. 30 shows an example of a candidate list 501 to represent several handwriting candidates corresponding to an input stroke to the user.

It is assumed here that a stroke 611 corresponding to the handwritten character “a” is input by the handwriting input operation executed on the edit screen 600.

If the stroke 611 is input by handwriting, the handwriting suggest processing module 308 obtains several handwriting candidates corresponding to the input stroke 611 (the handwritten character “a”) from the candidate stroke database 402B. Then, the handwriting suggest processing module 308 displays the handwriting candidates on the candidate list 501 on the edit screen 600.

It is assumed that three stroke strings are represented as handwriting candidates on the candidate list 501 in FIG. 30. Three stroke strings include a handwritten character string “apple”, a handwritten character string “ability”, and a handwritten character string “adaptor”.

Several stroke strings (handwritten character strings) starting with a leading handwritten character “a” are thus represented as the handwriting candidates to the user.

When one of three handwriting candidates on the candidate list 501 is selected by the user, the selected handwriting candidate is handled as a suggested stroke string. The suggested stroke string is displayed on the edit screen 600 so as to overlap with the stroke 611.

A suggested stroke string is displayed when a certain handwritten character is input, in the above explanations but, the entire body of the character does not need to be input by handwriting, and the suggested stroke string may be displayed when at least one stroke corresponding to a part of the character is input. This example will be hereinafter explained.

It is assumed here that the user is to input a handwritten character string “England”. It is also assumed that the handwritten character string “England” has already been stored in the candidate stroke database 402B.

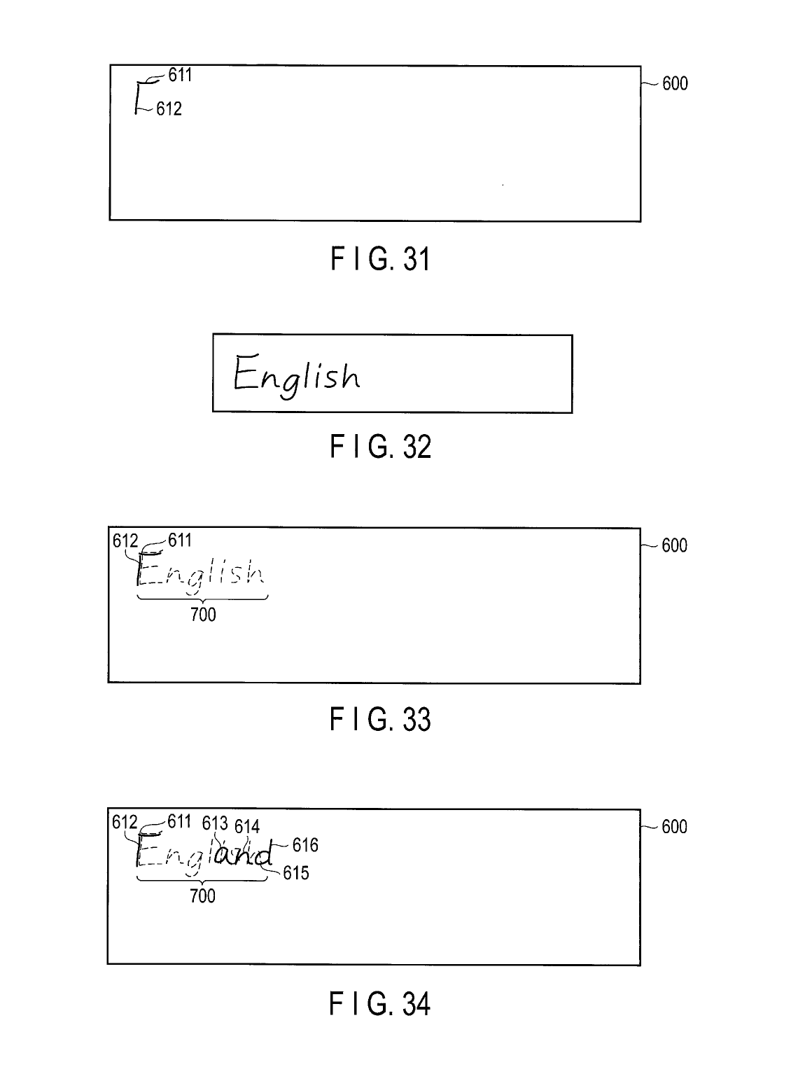

When strokes 611 and 612 corresponding to a part of a handwritten character “E” are input by handwriting on the edit screen 600 as shown in FIG. 31, the handwriting suggest processing module 308 searches the handwritten character string “English” shown in FIG. 32 as a suggested stroke string by referring to the candidate stroke database 402B. As shown in FIG. 33, the handwriting suggest processing module 308 displays the handwritten character string “English” as a suggested stroke string 700, on the edit screen 600.

The suggested stroke string “English” 700 may be displayed such that a leading part “E” of the suggested stroke string “English” 700 overlaps with an area where the strokes 611 and 612 are written.

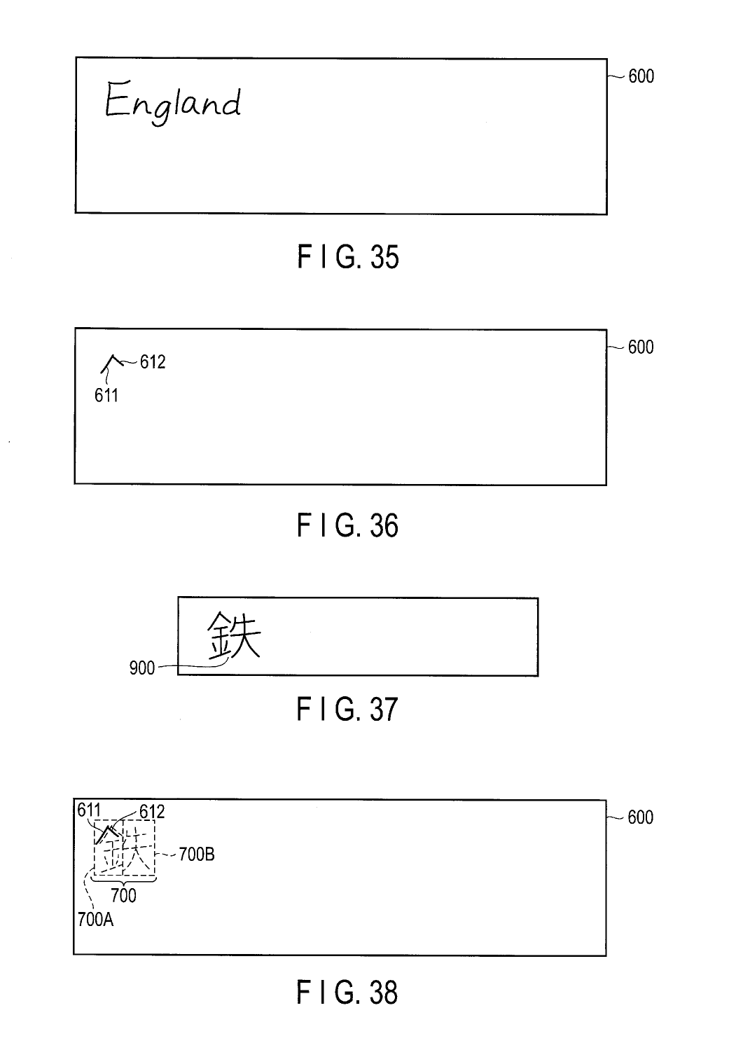

The user starts writing strokes 613 to 616 of a handwritten character string “and” such that the handwritten character string overlaps an area corresponding to “ish” in the displayed suggested stroke string 700 (FIG. 34). The handwriting suggest processing module 308 determines that a position where the handwritten character string “and” is written is at “ish” in the suggested stroke string 700. Then, the handwriting suggest processing module 308 executes processing of adopting “Engl” in the suggested stroke string 700 as an input and not adopting “ish” in the suggested stroke string 700 as an input. The adopted portion “Engl” in the suggested stroke string 700 is entered, and the unadopted portion “ish” in the suggested stroke string 700 is not entered. In other words, the strokes 611 and 612 corresponding to parts of “E” are completed with the adopted portion “Engl” in the suggested stroke string 700. The adopted portion “Engl” is displayed in the same style as the style of the strokes which are being input. Then, the unadopted portion “ish” in the suggested stroke string 700 is deleted and disappears from the edit screen 600, and the handwritten character string “England” including the completed handwritten character string “Engl” and the handwritten character string “and” which is written on the “ish” is displayed as shown in FIG. 35.

The above-explained configuration of displaying the suggested stroke string when at least one stroke corresponding to a part of a character is input is also preferable when a Kanji character is input by handwriting. This is because a Kanji character is generally composed of a number of strokes.

It is assumed here that the user is to input a Kanji character 850 shown in FIG. 40. It is also assumed that a stroke string corresponding to a handwritten Kanji character 900 shown in FIG. 37 has already been stored in the candidate stroke database 402B.

For example, when first two strokes 611 and 612 of a stroke string of the Kanji character 850 are input by handwriting on the edit screen 600 as shown in FIG. 36, the handwriting suggest processing module 308 searches the stroke string of the handwritten Kanji character 900 shown in FIG. 37 as a suggested stroke string by referring to the candidate stroke database 402B. This is because first two strokes of the stroke string of the handwritten Kanji character 900 have same feature as the strokes 611 and 612. As shown in FIG. 38, the handwriting suggest processing module 308 displays the stroke string of the handwritten Kanji character 900 as a suggested stroke string 700, on the edit screen 600.

In this case, the handwritten Kanji character 900 (i.e., the suggested stroke string 700) may be displayed such that the first two strokes of the stroke string of the handwritten Kanji character 900 (i.e., the suggested stroke string 700) overlap with an area where the strokes 611 and 612 are written.

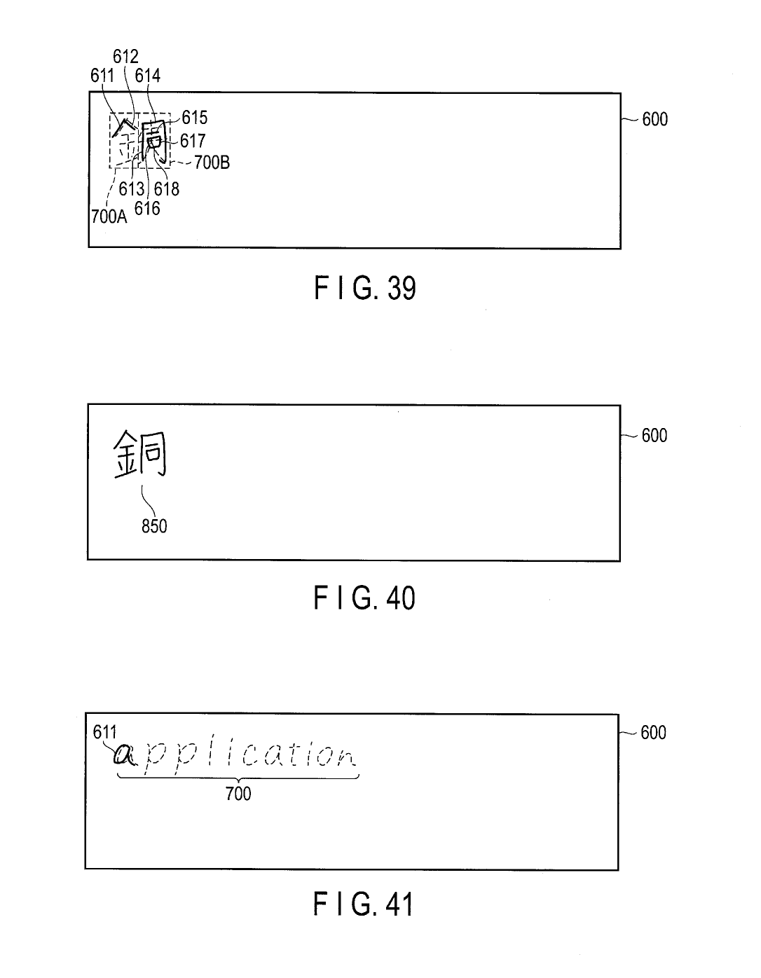

The handwritten Kanji character 900 (i.e., the suggested stroke string 700) is composed of several strokes which form its component 700A and several strokes which form the other component 700B. The user starts writing strokes 613 to 618 of a component of the Kanji character 850 such that the strokes overlap an area corresponding to the component 700B of the displayed handwritten Kanji character 900 (i.e., the suggested stroke string 700) (FIG. 39). The handwriting suggest processing module 308 executes processing of adopting the component 700A in the handwritten Kanji character 900 (i.e., the suggested stroke string 700) as an input and not adopting the component 700B in the handwritten Kanji character 900 (i.e., the suggested stroke string 700) as an input. The component 700A is entered, and the component 700B is not entered. In other words, the strokes 611 and 612 are completed with the component 700A, which is the adopted portion in the suggested stroke string 700. The component 700A which is the adopted portion is displayed in the same style as the style of the strokes which are being input. Then, the component 700B which is the unadopted portion in the handwritten Kanji character 900 (i.e., the suggested stroke string 700) is deleted and disappears from the edit screen 600, and the handwritten Kanji character 850 is displayed as shown in FIG. 40.

Next, processing of using a stroke of a predetermined shape which is input by handwriting and making a part or an entire body of a suggested stroke string adopted will be explained.

A stroke of an arbitrary predetermined shape can be used as a stroke of a predetermined shape but, for example, a stroke corresponding to a frame shape such as a round or a square may be used. The stroke corresponding to corresponding to the frame shape is used as a stroke to designate an adopted portion in a suggested stroke string (handwriting candidate). The stroke corresponding to the frame shape is used as a stroke to enable a part or an entire body of a suggested stroke string to be adopted even if no more characters need to be written.

It is assumed here that the user is to input a handwritten character string “appl”. It is also assumed that a handwritten character string “application” has already been stored in the candidate stroke database 402B.

When a stroke 611 corresponding to a character “a” is input by handwriting on the edit screen 600 as shown in FIG. 41, the handwriting suggest processing module 308 displays a handwritten character string “application” as a suggested stroke string 700 on the edit screen 600. The suggested stroke string 700 is displayed on the edit screen 600 such that a leading part “a” of the suggested stroke string 700 overlaps an area corresponding to the stroke 611.

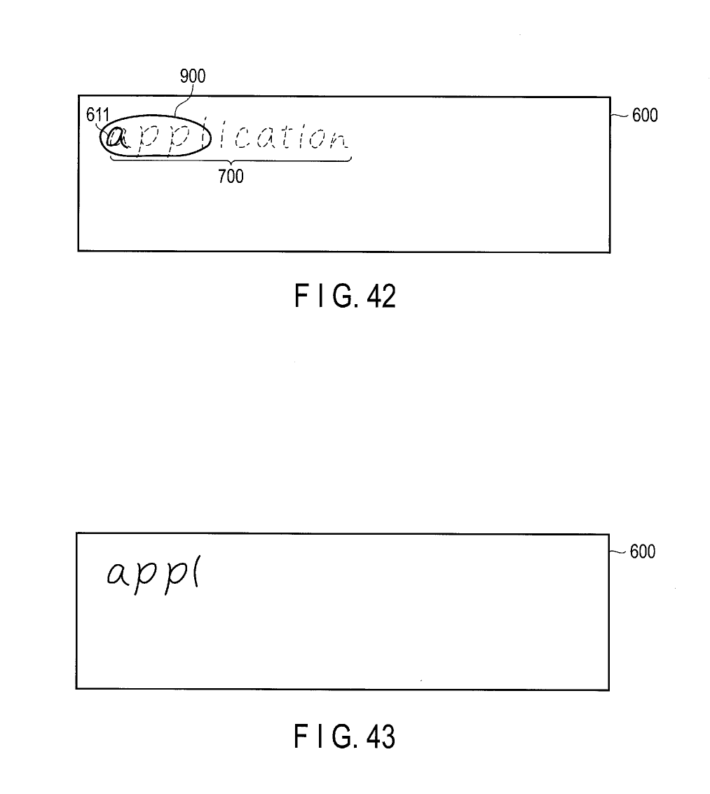

The user starts writing a frame-shaped stroke 900 such that the stroke overlaps an area corresponding to “appl” in the displayed suggested stroke string 700 or surrounds the area corresponding to “appl” (FIG. 42). The handwriting suggest processing module 308 determines that a position where the frame-shaped stroke 900 is written is at the area corresponding to “appl” in the suggested stroke string 700. The handwriting suggest processing module 308 determines an area (“appl”) where the frame-shaped stroke 900 is input, of the suggested stroke string 700, as an adopted portion.

Then, the handwriting suggest processing module 308 adopts “appl” in the suggested stroke string 700 as an input and deletes “ication” in the suggested stroke string 700 and the frame-shaped stroke 900 input by handwriting. Thus, “ication” in the suggested stroke string 700 and the frame-shaped stroke 900 input by handwriting disappear from the edit screen 600.

In other words, the stroke 611 corresponding to “a” is completed with the adopted portion “appl” in the suggested stroke string 700. In this case, the stroke “a” 611 may be replaced by the adopted portion “appl”. The adopted portion “appl” is displayed in the same style as the style of the stroke which is being input. Then, the unadopted portion “ication” in the suggested stroke string 700 and the frame-shaped stroke 900 disappear from the edit screen 600, and the completed handwritten character string “appl” alone is displayed as shown in FIG. 43.

If the frame-shaped stroke 900 is input by handwriting on the area corresponding to the entire body of “application” of the suggested stroke string 700, the entire body of the suggested stroke string 700 is adopted.

The frame-shaped stroke 900 which is written on a part of the suggested stroke string 700 is not used as a stroke handled as a base of handwriting suggestion, similarly to the stroke “-” 800. A new suggested stroke string corresponding to the frame-shaped stroke 900 is not therefore displayed.

If the frame-shaped stroke 900 is input by handwriting on an area which does not overlap the suggested stroke string 700, the frame-shaped stroke 900 is handled similarly to the other general stroke.

In the present embodiment, both the stroke “-” 800 (i.e., the stroke to enable a part or an entire body of the suggested stroke string to be deleted even if no more characters need to be written) and the frame-shaped stroke 900 (i.e., the stroke to enable a part or an entire body of the suggested stroke string to be adapted even if no more characters need to be written) are defined but, the stroke of either of the types alone may be used.

Even if the stroke of either of the types is input on the area corresponding to at least one preceding stroke (for example, “appl”) in the suggested stroke string 700 shown in FIG. 42, at least one subsequent stroke (for example, “ication”) in the suggested stroke string 700 is erased. In other words, if a stroke of a specific shape (i.e., the stroke “-” 800 or the frame-shaped stroke 900) is input on the area corresponding to “appl” in the suggested stroke string 700 shown in FIG. 42, the handwriting suggest processing module 308 executes at least processing of erasing “ication” in the suggested stroke string 700 (i.e., processing of making “ication” unadopted). The suggested stroke string can be thereby partially reflected on a handwritten page even if no more characters need to be written.

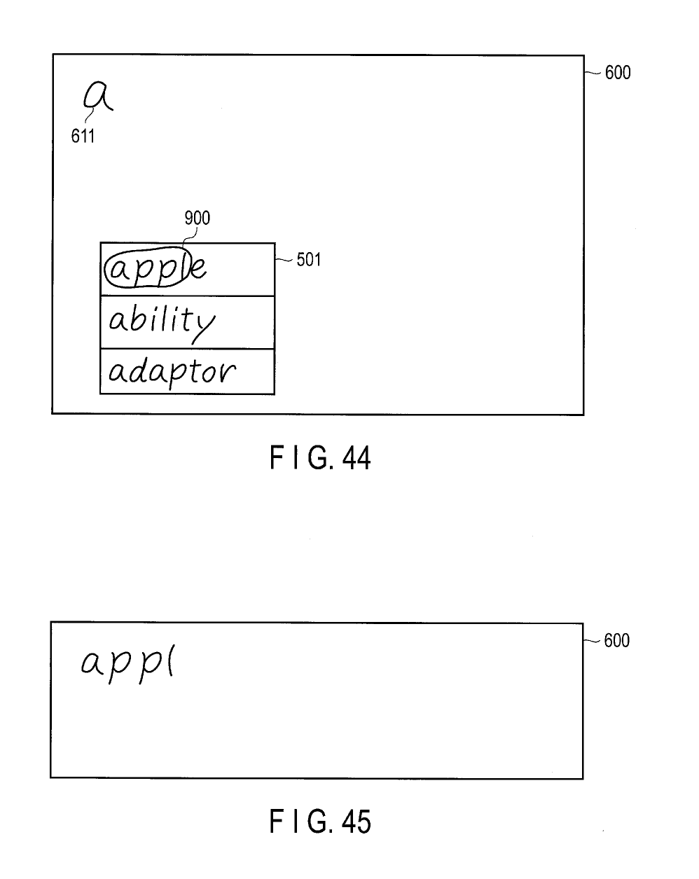

The frame-shaped stroke 900 may be input on the suggested stroke string displayed as handwriting candidates in the candidate list 501. An example of this case is shown in FIG. 44.

It is assumed that the stroke 611 is input by handwriting on the edit screen 600 and the candidate list 501 is displayed on the edit screen 600 by the handwriting suggest processing module 308, in FIG. 44.

If the frame-shaped stroke 900 is input by handwriting on the area corresponding to “appl” of the stroke string “apple” displayed as a handwriting candidate in the candidate list 501 or if the area corresponding to “appl” is designated by an arbitrary range selection tool, the handwriting suggest processing module 308 executes processing of adopting the portion “appl” alone of the stroke string “apple” as an input and not adopting “e” as an input. As shown in FIG. 45, the handwriting suggest processing module 308 displays the completed handwritten character string “appl” on the edit screen 600.

In a configuration of not using the stroke to enable a part or the entire body of the suggested stroke string to be erased but using the only stroke to enable a part or the entire body of the suggested stroke string to be adopted, the stroke to enable a part or the entire body of the suggested stroke string to be adopted may be the stroke “-”.

In the present embodiment, at least one first stroke made on the document displayed on the screen of the touch screen display 17 is received and displayed on the screen. In response to the input of the at least one first stroke, the suggested stroke string (first handwriting candidate) corresponding to the at least one first stroke is determined. The first handwriting candidate is a handwriting candidate conforming to the at least one first stroke. The suggested stroke string (first handwriting candidate) includes at least one stroke (second stroke), and the other stroke (third stroke) subsequent to the at least one second stroke. If at least one new stroke (fourth stroke) is input by handwriting in an area corresponding to the at least one third stroke, the suggested stroke determiner 308B receives the fourth stroke overlapping with the display area of the third stroke. The suggested stroke determiner 308B executes processing of adopting the at least one second stroke as an input and not adopting the at least one third stroke as an input. Tat is, the at least one second stroke and the fourth stroke are entered into the document, and the at least one third stroke is not entered. That is, the handwriting suggest processing module 308 enters not the third stroke but both the second stroke and the fourth stroke into the document in response to the input of the fourth stroke.

The user can therefore easily use a portion preceding the only portion which is to be unadopted, of the suggested stroke string (handwriting candidate), by merely inputting a new stroke of the portion which is to be unadopted in the displayed suggested stroke string, by handwriting.

Thus, a complicated operation of erasing a part of the suggested stroke string by an eraser tool does not need to be executed after adopting the entire body of the suggested stroke string, and multiple strokes can be input smoothly by handwriting.

Since various types of the processing of the present embodiment can be implemented by the computer program, the same advantages as those of the present embodiment can easily be obtained by installing the computer program in a computer via a computer-readable storage medium storing the computer program and by executing the computer program.

The CPU in the computer in which the computer program is installed can function as a hardware processor configured to execute the above-explained handwriting suggestion processing. The GPU in the computer can function as a display processor configured to display each stroke on the screen.

In addition, the example of using the tablet computer is explained in the present embodiment, but the handwritten document processing function of the present embodiment can also be applied to a general desktop PC. In this case, the tablet serving as the input device for handwriting input or the like may be connected to the desktop PC.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device, comprising:
a display configured to detect a stroke made on a screen of the display and display the stroke on the screen;
a memory configured to store a document; and
a hardware processor configured to:
display the document on the screen;
receive at least one first stroke made on the document displayed on the screen;
display the at least one first stroke on the screen;
determine a first handwriting candidate comprising a second stroke and a third stroke subsequent to the second stroke in response to an input of the at least one first stroke;
display the first handwriting candidate on the screen;
receive a fourth stroke overlapping with an display area of the third stroke made on the screen; and
enter not the third stroke but both the second stroke and the fourth stroke into the document in response to an input of the fourth stroke.

2. The electronic device of claim 1, wherein
the at least one first stroke is displayed in a first style on the screen, and
the first handwriting candidate is displayed in a second style different from the first style on the screen.

3. The electronic device of claim 1, wherein
the hardware processor is further configured to display one or more handwriting candidates on the screen based on the at least one first stroke, the one or more handwriting candidates obtained from handwritten document data, and
the first handwriting candidate is a handwriting candidate selected by a user operation from the one or more handwriting candidates.

4. The electronic device of claim 1, wherein
if a fifth stroke having a first shape and overlapping with the display area of the third stroke is received, the hardware processor executes processing of entering the second stroke into the document and deleting the third stroke and the fifth stroke.

5. The electronic device of claim 1, wherein
if a sixth stroke having a first shape and overlapping with a display area of the second stroke is received, the hardware processor executes at least processing of deleting the third stroke.

6. A method comprising:
displaying a document on a screen of a display;
receiving at least one first stroke made on the document displayed on the screen;
displaying the at least one first stroke on the screen;
determining a first handwriting candidate comprising a second stroke and a third stroke subsequent to the second stroke in response to an input of the at least one first stroke;
displaying the first handwriting candidate on the screen;
receiving a fourth stroke overlapping with an display area of the third stroke made on the screen; and
entering not the third stroke but both the second stroke and the fourth stroke into the document in response to an input of the fourth stroke.

7. The method of claim 6, wherein
the at least one first stroke is displayed in a first style on the screen, and
the first handwriting candidate is displayed in a second style different from the first style on the screen.

8. The method of claim 6, further comprising:
displaying one or more handwriting candidates on the screen based on the at least one first stroke, the one or more handwriting candidates being obtained from handwritten document data,
wherein the first handwriting candidate is a handwriting candidate selected by a user operation from the one or more handwriting candidates.

9. The method of claim 6, wherein
if a fifth stroke having a first shape and overlapping with the display area of the third stroke is received, the second stroke is entered into the document and the third stroke and the fifth stroke are deleted.

10. The method of claim 6, wherein
if a sixth stroke having a first shape and overlapping with a display area of the second stroke is received, the third stroke is deleted.
